(19) United States
(12) Patent Application Publication
(10) Pub. No.: US 2013/0219123 A1
(43) Pub. Date: Aug. 22, 2013

(54) MULTI-CORE PROCESSOR SHARING L1 CACHE

(71) Applicant: SAMSUNG ELECTRONICS CO., LTD., (US)

(72) Inventor: HOI JIN LEE, SEOUL (KR)

(73) Assignee: SAMSUNG ELECTRONICS CO., LTD., SUWON-SI, GYEONGGI-DO (KR)

(21) Appl. No.: 13/713,088

(22) Filed: Dec. 13, 2012

(30) Foreign Application Priority Data
Feb. 20, 2012 (KR) 10-2012-0016746

(51) Int. Cl. G06F 12/08

(52) U.S. Cl. CPC G06F 12/0875
USPC 711/123

(57) ABSTRACT

A multi-core processor comprises a level 1 (L1) cache and two independent processor cores each sharing the L1 cache.

### CROSS-REFERENCE TO RELATED APPLICATIONS

This application claims priority under 35 U.S.C. §119(a) from Korean Patent Application No. 10-2012-0016746 filed on Feb. 20, 2012, the subject matter of which is hereby incorporated by reference.

### BACKGROUND

The present inventive concept relates to multi-core processors, and more particularly, to multi-core processors including a plurality of processor cores sharing a level 1 (L1) cache, and devices having same.

To improve performance of a system on chip (SoC), certain circuits and/or methods that effectively increase the operating frequency of a central processing unit (CPU) within the SoC has been proposed. One approach to increasing the operating frequency of the CPU increases a number of pipeline stages.

One technique referred to as dynamic frequency and voltage scaling (DVFS) has been successfully used to reduce power consumption in computational systems, particularly those associated with mobile devices. However, under certain workload conditions, the application of DVFS to a CPU has proved inefficient.

### SUMMARY

Certain embodiments of the inventive concept are directed to multi-core processors, including a level 1 (L1) cache, and more particularly, to two (2) independent processor cores each sharing the L1 cache.

In one embodiment, the inventive concept provides a multi-core processor comprising; a level 1 (L1) cache; and two independent processor cores each sharing the L1 cache.

In another embodiment, the inventive concept provides a data processing device comprising; a memory, a multi-core processor controlling a data access operation of the memory, wherein the multi-core processor includes a level 1 (L1) cache and two independent processor cores each sharing the L1 cache.

In another embodiment, the inventive concept provides a multi-core processor comprising; a first processor core having an integrated level 1 (L1) cache and a first level 2 (L2) cache, the L1 cache including an L1 data cache and an L1 instruction cache, and the first processor core operating in response to a first set of instructions stored in the L1 instruction cache to execute a first task using the L1 data cache and the first L2 cache, and a second processor core having a second level 2 (L2) cache and operating in response to a second set of instructions to execute a second task using the L1 cache and the first L2 cache, wherein the first task and the second task are independently executed by sharing the L1 cache between the first processor core and the second processor core.

### BRIEF DESCRIPTION OF THE DRAWINGS

These and/or other aspects and advantages of the inventive concept will become apparent and more readily appreciated from the following description of the embodiments, taken in conjunction with the accompanying drawings of which:

FIG. 1 is a block diagram illustrating a multi-core processor sharing a level 1 (L1) cache according to an embodiment of the inventive concept;

FIG. 2 is a block diagram illustrating a multi-core processor sharing a L1 cache according to another embodiment of the inventive concept;

FIG. 3 is a block diagram illustrating a multi-core processor sharing a L1 cache according to still another embodiment of the inventive concept;

FIG. 4 is a block diagram illustrating a multi-core processor sharing a L1 cache according to still another embodiment of the inventive concept;

FIG. 5 is a block diagram illustrating a multi-core processor sharing a L1 cache according to still another embodiment of the inventive concept;

FIG. 6 is a general flowchart summarizing operation of the multi-core processor illustrated in any one of FIGS. 1 to 5;

FIG. 7 is a block diagram illustrating a data processing device including the multi-core processor illustrated in any one of FIGS. 1 to 5;

FIG. 8 is a block diagram illustrating another data processing device including the multi-core processor illustrated in any one of FIGS. 1 to 5; and

FIG. 9 is a block diagram illustrating yet another data processing device including the multi-core processor illustrated in any one of FIGS. 1 to 5.

### DETAILED DESCRIPTION

Certain embodiments of the present inventive concept now will now be described in some additional detail with reference to the accompanying drawings. The inventive concept may, however, be embodied in many different forms and should not be construed as being limited to only the illustrated embodiments. Rather, these embodiments are provided so that this disclosure will be thorough and complete, and will fully convey the scope of the invention to those skilled in the art. Throughout the written description and drawings, like reference numbers and label are used to denote like or similar elements.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

Each of a plurality of processor cores integrated in a multi-core processor according to an embodiment of the inventive concept may physically share a “level 1” (L1) cache.

Accordingly, since each of the plurality of processor cores physically shares the L1 cache, the multi-core processor may perform switching or CPU scaling between the plurality of processor cores without increasing a switching penalty while performing a specific task.

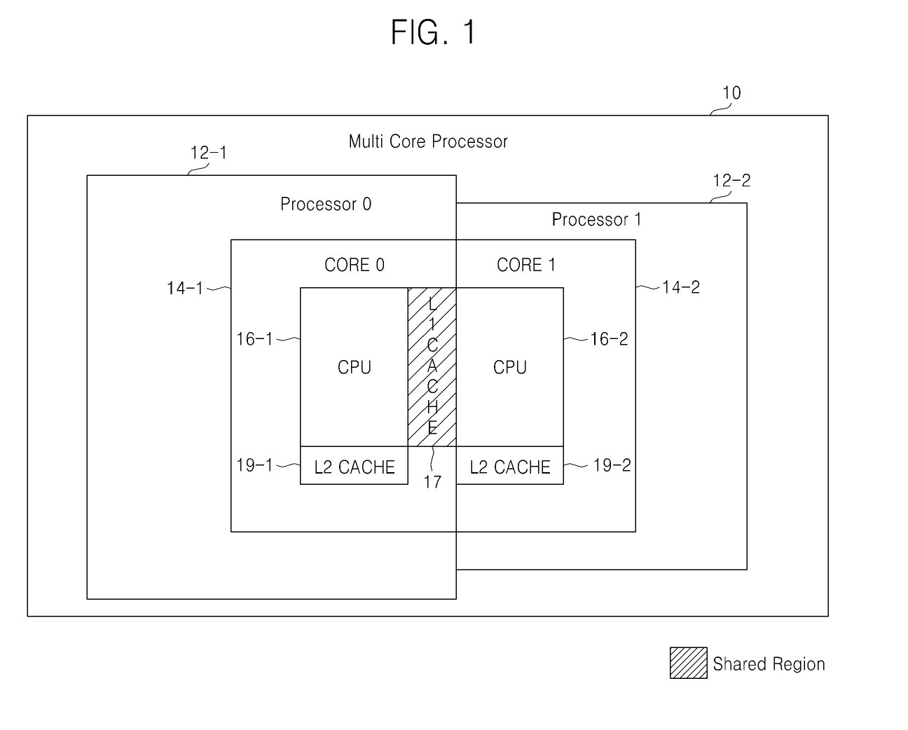

FIG. 1 is a block diagram illustrating a multi-core processor sharing an L1 cache according to an embodiment of the inventive concept. Referring to FIG. 1, a multi-core processor 10 includes two processors 12-1 and 12-2. Accordingly, the multi-core processor 10 may be called a dual-core processor.

A first processor 12-1 includes a processor core 14-1. The processor core 14-1 includes a CPU 16-1, a level 1 cache (hereinafter, called ‘L1 cache’) 17, and a level 2 cache (hereinafter, called ‘L2 cache’) 19-1. The L1 cache 17 may include an L1 data cache and an L1 instruction cache. A second processor 12-2 includes a processor core 14-2. The processor core 14-2 includes a CPU 16-2, the L1 cache 17 and an L2 cache 19-2.

Here, the L1 cache 17 is shared by the processor core 14-1 and the processor core 14-2. The L1 cache 17 may be integrated or embedded in a processor operating at a comparably high operating frequency among the two processor cores 14-1 and 14-2, e.g., the processor core 14-1.

The operating frequency for each independent processor core 14-1 and 14-2 may be different. For example, an operating frequency of the processor core 14-1 may be higher than an operating frequency of the processor core 14-2.

It is assumed that the processor core 14-1 is a processor core that maximizes performance even though workload performance capability (as measured, for example using a Microprocessor without Interlocked Pipeline Stages (MIPS)/mW scale) per unit power consumption under a relatively high workload is low. It is further assumed that the processor core 14-2 is a processor core that maximizes workload performance capability (MIPS/mW) per unit power consumption even though maximum performance under a relatively low workload is low.

In the illustrated example of FIG. 1, each processor core 14-1 or 14-2 includes an L2 cache 19-1 or 19-2. However, in other embodiments, each processor core 14-1 or 14-2 may share a single L2 cache. Further, while each processor core 14-1 or 14-2 is illustrated as incorporating a separate L2 cache, the L2 caches may be provided external to each processor core 14-1 or 14-2.

As the L1 cache 17 is shared, the processor core 14-2 may transmit data to the L1 cache while executing a specific task. Accordingly, the processor core 14-2 may acquire control over the L1 cache 17 from the processor core 14-1 while executing the specific task. The specific task may be, for example, execution of a program. Moreover, as the L1 cache 17 is shared, the processor 14-1 may transmit data to the L1 cache 17 while executing a specific task. Accordingly, the processor core 14-1 may acquire control over the L1 cache 17 from the processor 14-2 while executing a specific task.

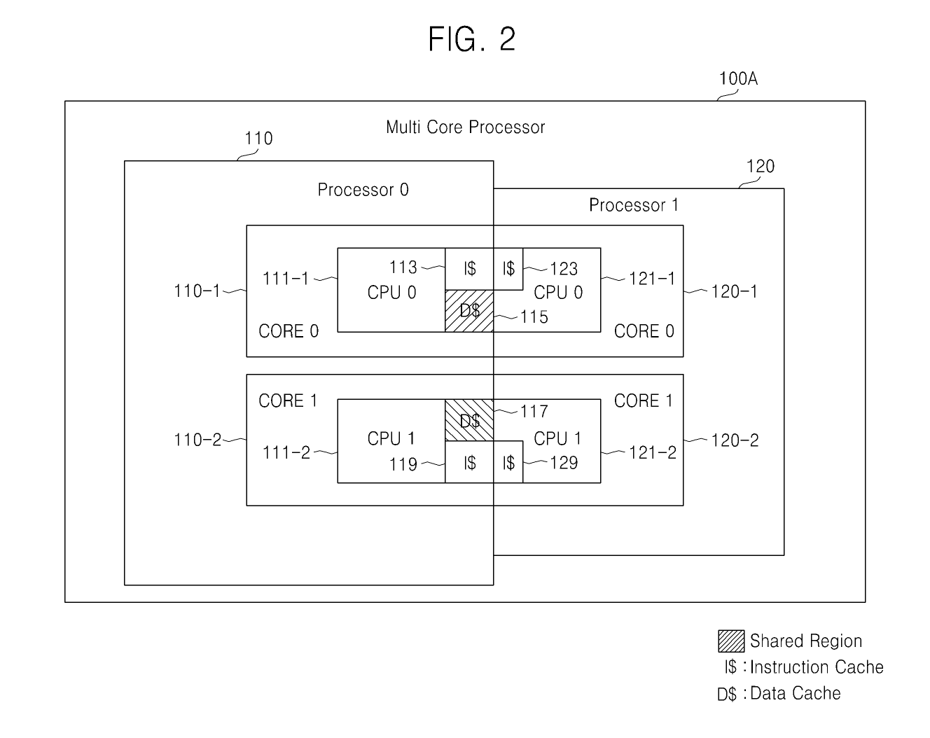

FIG. 2 is a block diagram illustrating a multi-core processor sharing the L1 cache according to another embodiment of the inventive concept. Referring to FIG. 2, a multi-core processor 100A includes two processors 110 and 120.

The first processor 110 includes a plurality of processor cores 110-1 and 110-2. A first processor core 110-1 includes a CPU 111-1, an L1 instruction cache 113, and an L1 data cache 115. A second processor core 110-2 includes a CPU 111-2, an L1 data cache 117 and an L1 instruction cache 119.

The second processor 120 includes a plurality of processor cores 120-1 and 120-2. A third processor core 120-1 includes a CPU 121-1, an L1 instruction cache 123, and an L1 data cache 115. Here, the L1 data cache 115 is shared by each processor core 110-1 and 120-1. According to an example embodiment, the L1 data cache 115 is embedded in or integrated to the first processor core 110-1 having a relatively high operating frequency.

A fourth processor core 120-2 includes a CPU 121-2, the L1 data cache 117, and an L1 instruction cache 129. Here, the L1 data cache 117 is shared by each processor core 110-2 or 120-2. According to an example embodiment, the L1 data cache 117 is embedded in or integrated to the second processor core 110-2 having a relatively high operating frequency.

For example, when the first processor 110 includes a plurality of processor cores 110-1 and 110-2, the second processor 120 includes a plurality of processor cores 120-1 and 120-2, and the L1 data cache 115 is not shared, CPU scaling or CPU switching may be performed as follows. That is, CPU scaling or CPU switching is performed in a following order: the processor core 120-1→the plurality of processor cores 120-1 and 120-2→the processor core 110-1→the plurality of processor cores 110-1 and 110-2. Here, when switching is performed from the plurality of processor cores 120-1 and 120-2 to the processor core 110-1, a switching penalty (again, as may be measured using a MIPS/mW scale) increases considerably.

However, as illustrated in FIG. 2, when each L1 data cache 115 and 117 is shared, CPU scaling or CPU switching may be performed as follows.

CPU scaling or CPU switching may be performed in a following order: the processor core 120-1→the plurality of processor cores 120-1 and 120-2→the plurality of processor cores 110-1 and 110-2.

Since each L1 data cache 115 and 117 is shared, CPU scaling or CPU switching from the plurality of processor cores 120-1 and 120-2 to the processor core 110-1 may be skipped.

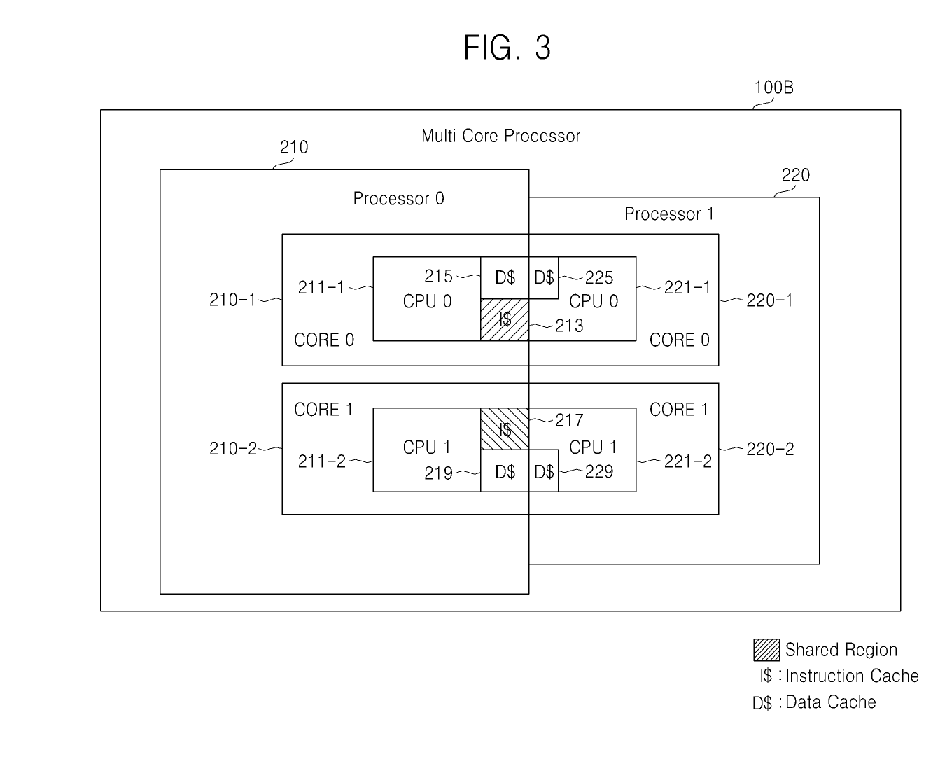

FIG. 3 is a block diagram illustrating a multi-core processor sharing the L1 cache according to still another embodiment of the inventive concept. Referring to FIG. 3, a multi-core processor 100B includes two processors 210 and 220.

A first processor 210 includes a plurality of processor cores 210-1 and 210-2. A first processor core 210-1 includes a CPU 211-1, an L1 data cache 215 and an L1 instruction cache 213. A second processor core 210-2 includes a CPU 211-2, an L1 instruction cache 217 and an L1 data cache 219.

A second processor 220 includes a plurality of processor cores 220-1 and 220-2. A third processor core 220-1 includes a CPU 221-1, an L1 data cache 225, and an L1 instruction cache 213. Here, the L1 instruction cache 213 is shared by each processor core 210-1 and 220-1. According to an example embodiment, the L1 instruction cache 213 is embedded in or integrated to a first processor core 210-1 whose operating frequency is relatively high. A fourth processor core 220-2 includes a CPU 221-2, the L1 instruction cache 217 and an L1 data cache 229. Here, the L1 instruction cache 217 is shared by each processor core 210-2 and 220-2. According to the illustrated embodiment of FIG. 3, the L1 instruction cache 217 is embedded in or integrated to a second processor core 210-2 whose operating frequency is relatively high.

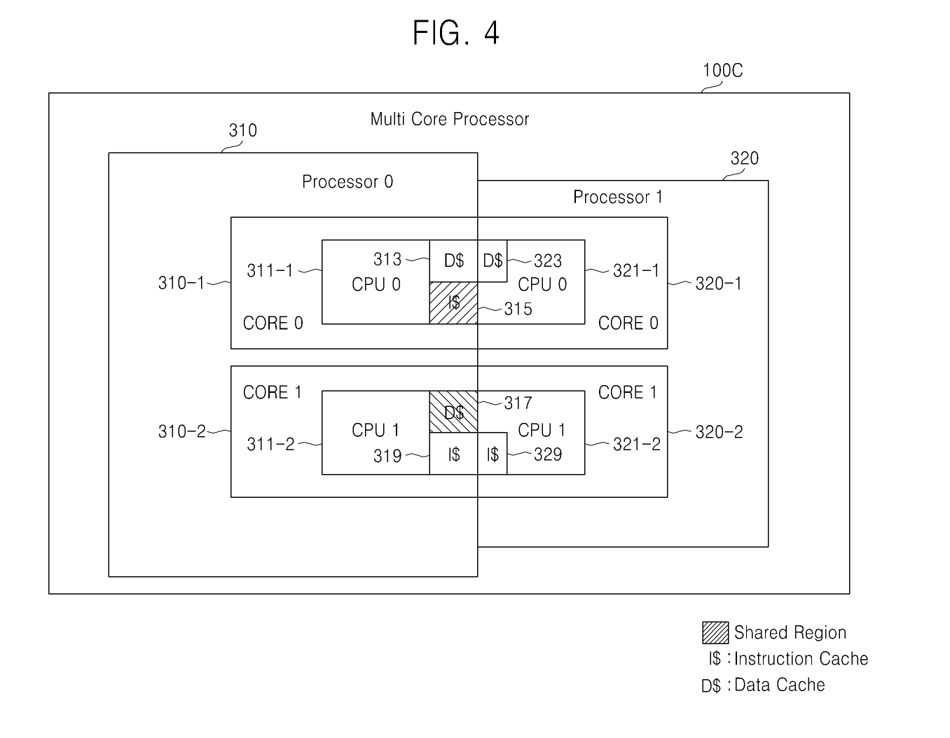

FIG. 4 is a block diagram illustrating a multi-core processor sharing an L1 cache according to still another embodiment of the inventive concept. Referring to FIG. 4, a multi-core processor 100C includes two processors 310 and 320.

A first processor 310 includes a plurality of processor cores 310-1 and 310-2. A first processor core 310-1 includes a first CPU 311-1, an L1 data cache 313 and an L1 instruction cache 315. A second processor core 310-2 includes a CPU 311-2, an L1 data cache 317 and an L1 instruction cache 319.

A second processor 320 includes a plurality of processor cores 320-1 and 320-2. A third processor core 320-1 includes a CPU 321-1, an L1 data cache 323 and the L1 instruction cache 315. Here, the first L1 instruction cache 315 is shared by each processor core 310-1 and 320-1. According to an example embodiment, the first L1 instruction cache 315 is embedded in or integrated into the first processor core 310-1 whose operating frequency is relatively high. A fourth processor core 320-2 includes a CPU 321-2, the L1 data cache 317 and an L1 instruction cache 329. Here, the L1 data cache 317 is shared by each processor core 310-2 and 320-2. According to the illustrated embodiment of FIG. 4, the L1 data cache 317 is embedded in or integrated into the second processor core 310-2 whose operating frequency is relatively high.

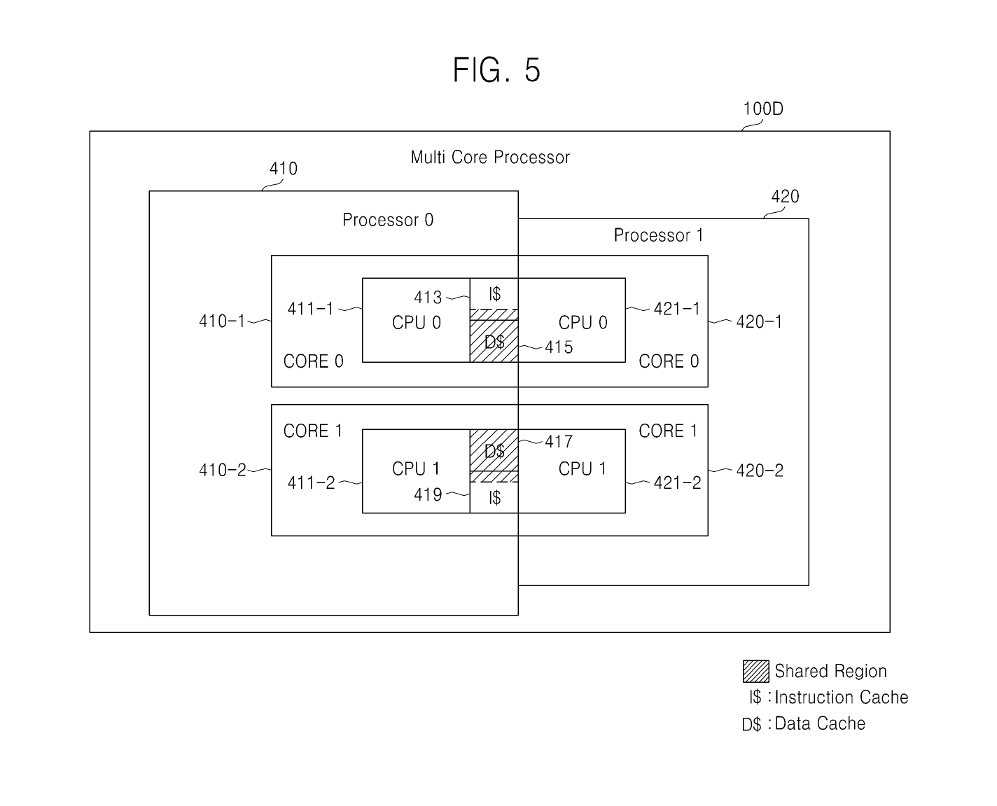

FIG. 5 is a block diagram illustrating a multi-core processor sharing an L1 cache according to still another embodiment of the inventive concept. Referring to FIG. 5, a multi-core processor 100D includes two processors 410 and 420.

A first processor 410 includes a plurality of processor cores 410-1 and 410-2. A first processor core 410-1 includes a CPU 411-1, an L1 instruction cache 413 and an L1 data cache 415. A second processor core 410-2 includes a CPU 411-2, an L1 data cache 417 and an L1 instruction cache 419.

A second processor 420 includes a plurality of processor cores 420-1 and 420-2. A third processor core 420-1 includes a CPU 421-1, an L1 instruction cache 413 and the L1 data cache 415. Here, at least one part of the L1 instruction cache 413 is shared by each processor core 410-1 and 420-1, and at least one part of the L1 data cache 415 is shared by each processor core 410-1 and 420-1. According to the illustrated embodiment of FIG. 5, the L1 instruction cache 413 and the L1 data cache 415 are embedded in or integrated to the first processor core 410-1 whose operating frequency is relatively high. A fourth processor core 420-2 includes a CPU 421-2, the L1 data cache 417 and an L1 instruction cache 419. Here, at least one part of the L1 data cache 417 is shared by each processor core 410-2 and 420-2, and at least one part of the L1 instruction cache 419 is shared by each processor core 410-2 and 420-2. According to the illustrated embodiment of FIG. 4, the L1 data cache 417 and the L1 instruction cache 419 are embedded in or integrated to the second processor core 410-2 whose operating frequency is relatively high.

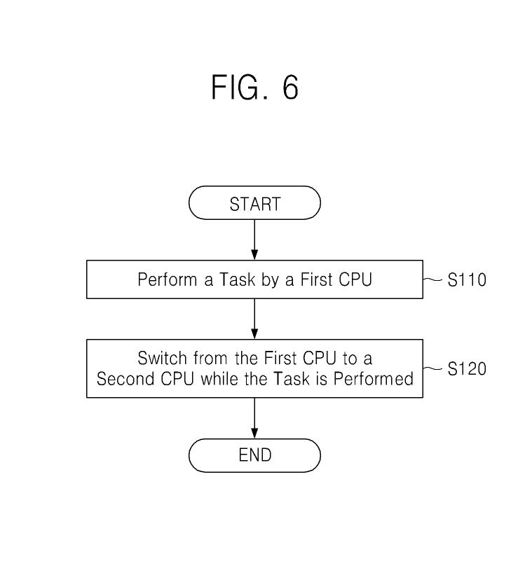

FIG. 6 is a general flowchart summarizing operation of a multi-core processor like the ones described above in relation to FIGS. 1 to 5. Referring to FIGS. 1 to 6, since a processor 12-2, 120, 220, 320 or 420 whose operating frequency is relatively low may access or use an L1 cache 17, 115 and 117, 213 and 217, 315 and 317, 413 and 415 or 417 and 419 integrated to a processor 12-1, 110, 210, 310 or 410 whose operating frequency is relatively high, performance of the processor 12-2, 120, 220, 320, or 420 whose operating frequency is relatively low may be improved.

Since the L1 cache is shared, the processor 12-2, 120, 220, 320 or 420 whose operating frequency is relatively low may transmit data by using the L1 cache during switching between processors. This makes it possible to switch from the processor 12-2, 120, 220, 320 or 420 whose operating frequency is relatively low to the processor 12-1, 110, 210, 310 or 410 whose operating frequency is relatively high during a specific task.

For example a specific task may be performed by a CPU embedded in the processor 12-2, 120, 220, 320 or 420 whose operating frequency is low (S110). While the specific task is performed by the CPU, since the L1 cache is shared, it is possible to switch from the low operating frequency CPU to a CPU embedded in the processor 12-1, 110, 210, 310 or 410 whose operating frequency is high (S120).

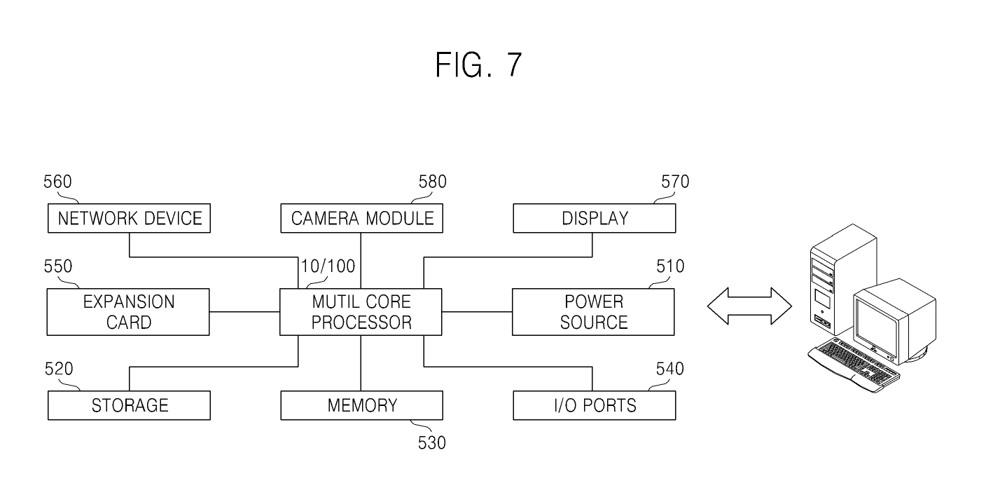

FIG. 7 is a block diagram illustrating a data processing device including a multi-core processor like the ones described in relation to FIGS. 1 to 5. Referring to FIG. 7, the data processing device may be embodied in a personal computer (PC) or a data server.

The data processing device includes a multi-core processor 10 or 100, a power source 510, a storage device 520, a memory 530, input/output ports 540, an expansion card 550, a network device 560, and a display 570. According to an example embodiment, the data processing device may further include a camera module 580.

The multi-core processor 10 or 100 may be embodied in one of the multi-core processor 10, 100A to 100D (collectively 100) illustrated in FIGS. 1 to 5. The multi-core processor 10 or 100 including at least two processor cores includes an L1 cache shared by each of the at least two processor cores. Each of the at least two processor cores may access the L1 cache exclusively.

The multi-core processor 10 or 100 may control an operation of each element 10, 100, 520 to 580. A power source 510 may supply an operating voltage to the each element 10, 100, 520 to 580. A storage device 520 may be embodied in a hard disk drive or a solid state drive (SSD).

The memory 530 may be embodied in a volatile memory or a non-volatile memory. According to an example embodiment, a memory controller which may control a data access operation of the memory 530, e.g., a read operation, a write operation (or a program operation), or an erase operation, may be integrated or built in the multi-core processor 10 or 100. According to an example embodiment, the memory controller may be embodied in the multi-core processor 10 or 100 and the memory 530.

The input/output ports 540 mean ports which may transmit data to a data storage device or transmit data output from the data storage device to an external device.

The expansion card 550 may be embodied in a secure digital (SD) card or a multimedia card (MMC). According to an example embodiment, the expansion card 550 may be a Subscriber Identification Module (SIM) card or a Universal Subscriber Identity Module (USIM) card.

The network device 560 means a device which may connect a data storage device to a wire network or wireless network.

The display 570 may display data output from the storage device 520, the memory 530, the input/output ports 540, the expansion card 550 or the network device 560.

The camera module 580 means a module which may convert an optical image into an electrical image. Accordingly, an electrical image output from the camera module 580 may be stored in the storage device 520, the memory 530 or the expansion card 550. In addition, an electrical image output from the camera module 580 may be displayed through the display 570.

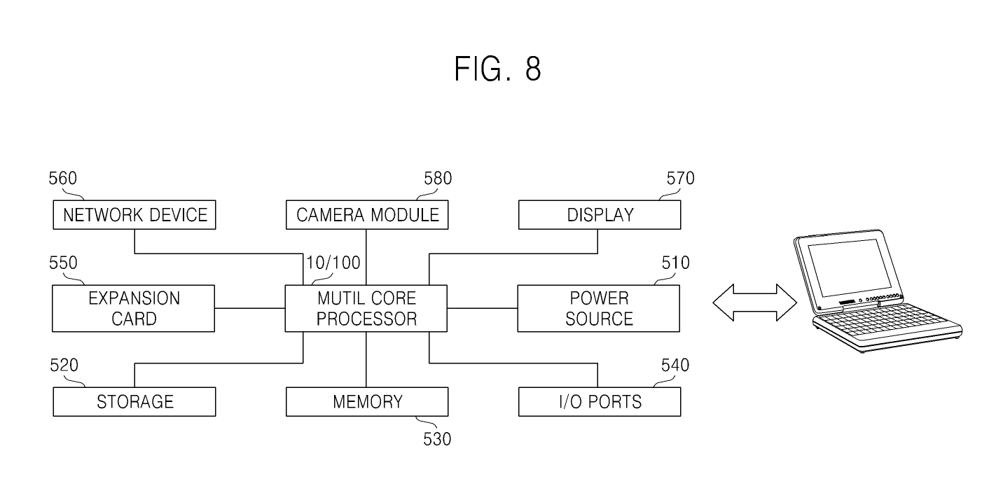

FIG. 8 is a block diagram illustrating another data processing device including a multi-core processor like the ones described in relation to FIGS. 1 to 5. Referring to FIGS. 7 and 8, the data processing device of FIG. 8 may be embodied in a laptop computer.

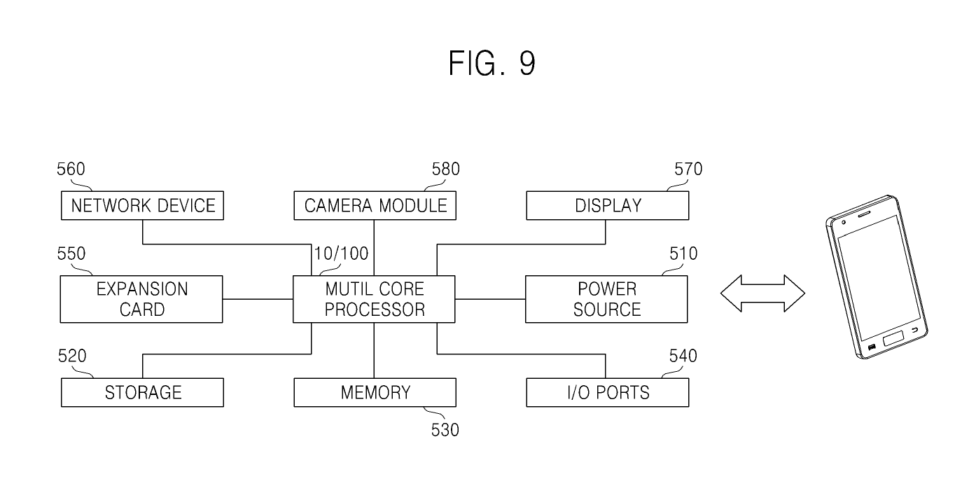

FIG. 9 is a block diagram illustrating still another data processing device including a multi-core processor like the ones described in relation to FIGS. 1 to 5. Referring to FIGS. 7 and 9, a data processing device of FIG. 9 may be embodied in a portable device. The portable device may be embodied in a cellular phone, a smart phone, a tablet PC, a personal digital assistant (PDA), an enterprise digital assistant (EDA), a digital still camera, a digital video camera, a portable multimedia player (PMP), a personal navigation device or a portable navigation device (PND), a handheld game console, or an e-book.

Each of at least two processor cores integrated to a multi-core processor according to an embodiment of the inventive concepts may share an L1 cache integrated to the multi-core processor.

Accordingly, a processor core operating at a relatively low frequency among the at least two processor cores may share and use an L1 cache integrated to a processor core operating at a relatively high frequency among the at least two processor cores, so that it may increase an operating frequency of the processor operating at a low frequency. Additionally, as an L1 cache is shared, CPU scaling or CPU switching may be possible during a specific task.

Although a few embodiments of the inventive concept have been shown and described, it will be appreciated by those skilled in the art that changes may be made in these embodiments without departing from the scope of the inventive concept defined by the appended claims and their equivalents.

What is claimed is:

1. A multi-core processor comprising:
a level 1 (L1) cache; and
two independent processor cores each sharing the L1 cache.

2. The multi-core processor of claim 1, wherein the L1 cache includes at least one of a data cache and an instruction cache.

3. The multi-core processor of claim 1, wherein, when the L1 cache includes a data cache and an instruction cache, each of the two independent processor cores shares at least one part of the data cache and at least one part of the instruction cache.

4. The multi-core processor of claim 1, wherein the two independent processor cores have different operating frequencies.

5. The multi-core processor of claim 1, wherein each of the two independent processor cores accesses the L1 cache exclusively.

6. The multi-core processor of claim 1, wherein during execution of a single task, use of the two independent processor cores is switched using the L1 cache.

7. A data processing device comprising:
a memory; and
a multi-core processor controlling a data access operation of the memory,
wherein the multi-core processor includes; a level 1 (L1) cache, and two independent processor cores each sharing the L1 cache.

8. The data processing device of claim 7, wherein the L1 cache includes at least one of a data cache and an instruction cache.

9. The data processing device of claim 7, wherein, when the L1 cache includes a data cache and an instruction cache, each of the two independent processor cores shares at least one part of the data cache and at least one part of the instruction cache

10. The data processing device of claim 7, wherein a respective operating frequency for each one of the two independent processor cores is different from each other.

11. The data processing device of claim 7, wherein during execution of a single task, use of the two independent processor cores is switched using the L1 cache.

12. The data processing device of claim 7, wherein the data processing device is one of a personal computer, a laptop computer, and a portable device.

13. A multi-core processor comprising:
a first processor core having an integrated level 1 (L1) cache and a first level 2 (L2) cache, the L1 cache including an L1 data cache and an L1 instruction cache, and the first processor core operating in response to a first set of instructions stored in the L1 instruction cache to execute a first task using the L1 data cache and the first L2 cache; and
a second processor core having a second level 2 (L2) cache and operating in response to a second set of instructions to execute a second task using the L1 cache and the second L2 cache,
wherein the first task and the second task are independently executed by sharing the L1 cache between the first processor core and the second processor core.

14. The multi-core processor of claim 13, wherein the second set of instructions is stored in the L1 instruction cache.

15. The multi-core processor of claim 13, wherein during execution of the second task, operation of the second processor core switches to operation of the first processor core using the L1 cache.

16. The multi-core processor of claim 13, wherein the first processor core operates at a first frequency and the second processor core operates at a second frequency different from the first frequency.

17. The multi-core processor of claim 16, wherein the first frequency is higher than the second frequency.

18. The multi-core processor of claim 13, wherein execution of the first task and execution of the second task are independent in relation to respective use of the L1 cache.

19. The multi-core processor of claim 13, wherein the first L2 cache is integrated within the first processor core.

20. The multi-core processor of claim 13, wherein at least one of the first L2 cache and the second L2 core is provided external to the multi-core processor.
